(19) United States
(12) Patent Application Publication
(10) Pub. No.: US 2023/0349709 A1
(43) Pub. Date: Nov. 2, 2023

(54) INFORMATION PROCESSING APPARATUS AND SYSTEM

(71) Applicant: TOYOTA JIDOSHA KABUSHIKI KAISHA, Toyota-shi Aichi-ken (JP)

(72) Inventors: Yu NAGATA, Chofu-shi Tokyo-to (JP); Toshihiro NAKAMURA, Sunto-gun Shizuoka-ken (JP)

(73) Assignee: TOYOTA JIDOSHA KABUSHIKI KAISHA, Toyota-shi Aichi-ken (JP)

(21) Appl. No.: 18/135,767

(22) Filed: Apr. 18, 2023

(30) Foreign Application Priority Data
Apr. 27, 2022 (JP) 2022-073493

(51) Int. Cl. G01C 21/36; G01C 21/34; G06V 20/58

(52) U.S. Cl. CPC G01C 21/3602; G01C 21/3492; G06V 20/58

(57) ABSTRACT

An information processing apparatus comprises a controller configured to execute: determining traffic volume of large-sized vehicles in a vicinity of a first vehicle based on first data transmitted from the first vehicle; and mapping information on the traffic volume of the large-sized vehicles to road segments based on the results of the determination.

### CROSS REFERENCE TO THE RELATED APPLICATION

This application claims the benefit of Japanese Patent Application No. 2022-073493, filed on Apr. 27, 2022, which is hereby incorporated by reference.

### BACKGROUND

### Technical Field

The disclosure relates to vehicle control.

### Description of the Related Art

Prior to the operation of an automated vehicle, systems are known to search for routes that can improve fuel or electricity consumption. For example, by running vehicles in formation with a short distance between vehicles, aerodynamic drag can be reduced and fuel and electricity costs can be improved.

In this connection, the Japanese Patent Application Laid-Open No. 2008-275500 discloses a device that searches for a route along which a vehicle is traveling that is prone to slipstream effects.

### SUMMARY

The purpose of this disclosure is to reduce the vehicle's travel energy.

The first aspect of the present disclosure is an information processing apparatus comprising a controller configured to execute: determining traffic volume of large-sized vehicles in a vicinity of a first vehicle based on first data transmitted from the first vehicle; and mapping information on the traffic volume of the large-sized vehicles to road segments based on the results of the determination.

The second aspect of the present disclosure is an information processing system comprising an on-board device mounted on a first vehicle and a server device capable of communicating with the on-board device, wherein the on-board device comprises a first controller configured to execute: detecting a large-sized vehicle in a vicinity of the first vehicle based on an image captured by an on-board camera, and transmitting first data including a result of the detection to the server device; the server device comprises a second controller configured to execute: determining, based on the first data, traffic volume of the large-sized vehicles in a vicinity of the first vehicle; and mapping information on the traffic volume of the large-sized vehicles to road segments based on the results of the determination.

Another aspect of the present disclosure is a method to be executed by the device described above, or a computer-readable storage medium non-transiently storing a program to execute the method.

According to this disclosure, the vehicle's driving energy can be reduced.

### BRIEF DESCRIPTION OF THE DRAWINGS

FIG. 1 illustrates an overview of the vehicle system.

FIG. 2 illustrates the system configuration of the in-vehicle device 100.

FIG. 3 illustrates an overview of the video data and location information data stored in the storage 102.

FIG. 4 illustrates the components of the server apparatus 200 in detail.

FIG. 5 is an example of an image labeled by the segmentation process.

FIG. 6 is an example of data stored in the video database 202A.

FIG. 7 is an example of traffic data 202C.

FIG. 8 is a flowchart of the process performed by the in-vehicle device 100.

FIG. 9 is a flowchart of the process by which the server apparatus 200 generates a traffic volume map.

FIG. 10 is an example of a generated traffic volume map.

FIG. 11 is a flowchart of the process by which the server apparatus 200 generates the operation plan.

FIG. 12 is a flowchart of the process performed by the autonomous vehicle 300.

FIG. 13 illustrates the pattern of the traffic volume map in the second embodiment.

FIG. 14 illustrates the system configuration of the in-vehicle device 100 in the third embodiment.

FIG. 15 is an example of detection result data in the third embodiment.

FIG. 16 is a flowchart of the process performed by the in-vehicle device 100 in the third embodiment.

FIG. 17 illustrates the system configuration of the server apparatus 200 in the third embodiment.

FIG. 18 is a flowchart of the process performed by the server apparatus 200 in the third embodiment.

FIG. 19A is an example of data used by the server apparatus 200 in the fourth embodiment.

FIG. 19B is another example of data used by the server apparatus 200 in the fourth embodiment.

### DESCRIPTION OF THE EMBODIMENTS

There are technologies that improve fuel economy through the slipstream effect. In particular, if the target vehicle is an automated vehicle, by forming a group of vehicles with a short distance between them, it is possible to reduce air resistance and reduce the consumption of driving energy.

The fuel economy reduction effect of slipstreaming is greater the larger the vehicle size of the preceding vehicle. In this connection, there are technologies that determine the pairs of vehicles to be slipstreamed based on, for example, information on the operation of large-sized vehicles.

However, large-sized vehicles such as buses and trucks do not always operate as scheduled, and if the schedule is off, vehicles may not be able to merge with each other, resulting in cases where fuel consumption reductions are not achieved as planned. The information processing apparatus of the present disclosure solves such problems.

The information processing apparatus according to an aspect of the present disclosure comprises a controller configured to execute: determining traffic volume of large-sized vehicles in a vicinity of a first vehicle based on first data transmitted from the first vehicle; and mapping information on the traffic volume of the large-sized vehicles to road segments based on the results of the determination.

The first data is for detect large-sized vehicles and is generated by the first vehicle (probe car). The first data may be, for example, an image captured by an onboard camera or data showing the results of a large-sized vehicle detection executed on the first vehicle. When using images, machine learning, pattern matching, segmentation techniques, etc. may be used to detect the presence of large-sized vehicles. This allows the number of large-sized vehicles present in the vicinity of the first vehicle (probe car) to be determined.

Based on the results of this determination, the controller maps information on large-sized vehicle traffic volume onto the road segment. This would allow, for example, the generation of maps showing roads with more large-sized vehicles.

The results of the mapping (e.g., a map representing large-sized vehicle traffic volume) can be used to control the travel of non-probe car. For example, the generated map may be distributed to a controller installed in an automated vehicle. For example, when the information processing apparatus generates a travel route for an automated vehicle, it can refer to the map to find a route that is easy to perform formation driving (driving using slipstreams).

The first data may include time information and location information. According to such a configuration, it is possible to identify when and where large-sized vehicles were present, thus enabling more accurate determination of the volume of large-sized vehicle traffic. For example, there may be cases where the same large-sized vehicle is captured by multiple probe car, but by using time information and location information, the overlap can be detected.

In addition, the speed of large-sized vehicles in the vicinity of the probe car may be determined based on the first data.

For example, the speed of such a large vehicle can be determined based on the detection results of the large-sized vehicle and the speed information of the probe car, acquired over time. In some embodiments, if the speed of such large-sized vehicles is extremely slow or stationary, such vehicles may be excluded from the traffic volume calculation, since the slipstream effect will not be achieved.

Specific embodiments of the disclosure are described below based on the drawings. The hardware configuration, module configuration, functional configuration, etc. described in each embodiment are not intended to limit the technical scope of the disclosure to them alone, unless otherwise stated.

### First Embodiment

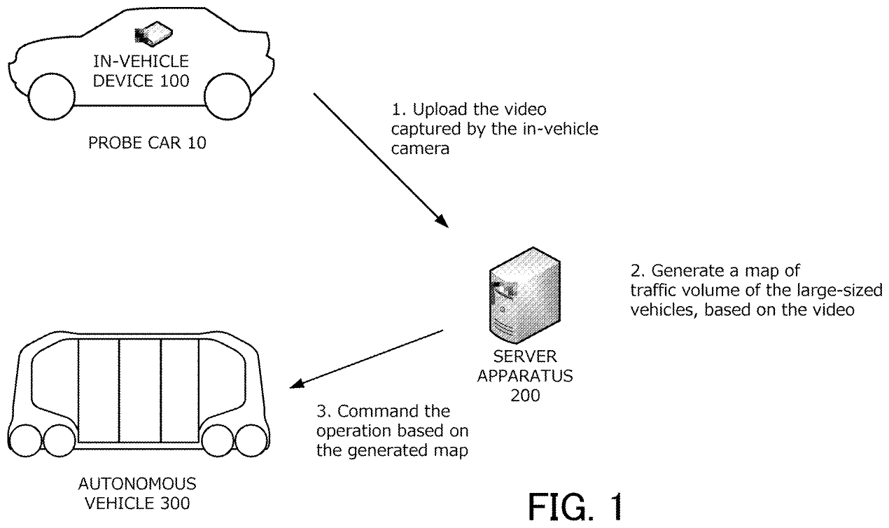

An overview of the first embodiment of the vehicle system will be described with reference to FIG. 1.

The vehicle system in this embodiment consists of a probe car 10, a server apparatus 200, and an autonomous vehicle 300.

Probe car 10 is a vehicle used to collect data on large-sized vehicle traffic volume. Probe car 10 may be an autonomous vehicle or a driver-operated vehicle. The 10 probe car can be, for example, ordinary vehicles that have signed a data provision contract with a service provider.

Autonomous vehicle 300 is an automated vehicle that provides a predetermined service. Autonomous vehicle 300 may be a vehicle that transports passengers or cargo, or it may be a mobile store vehicle. Autonomous vehicle 300 can run autonomously and provide predetermined services in accordance with commands transmitted from server apparatus 200.

The server apparatus 200 is a device that controls the operation of the autonomous vehicle 300. The server apparatus 200 generates a map representing the traffic volume of large-sized vehicles based on the data collected from the probe car 10, and uses the map to determine a travel route for the autonomous vehicle 300.

In the following description, a large-sized vehicle shall be defined as a vehicle with a size (e.g. width, height, or frontal projected area, etc.) greater than a predetermined value. The predetermined value should be greater than that of a standard passenger car (e.g., a passenger car with a capacity of 10 or less). Examples of large-sized vehicles include passenger vehicles (route buses, sightseeing buses, school buses, etc.), cargo vehicles with van-type cargo compartments, cargo vehicles carrying or towing containers, and tank trucks.

The following is a description of each element that makes up the system.

Probe car 10 is a connected car with the ability to communicate with external networks. The probe car 10 is equipped with an in-vehicle device 100.

The in-vehicle device 100 is a computer for collecting information. In this system, the in-vehicle device 100 has a camera installed facing the front of the vehicle and transmits the captured video to the server apparatus 200 at a predetermined timing. Hereafter, the video captured by the in-vehicle device 100 will be referred to as in-vehicle video.

The in-vehicle device 100 may be a device that provides information to the occupants of the probe car 10 (e.g., a car navigation device), or it may be an electronic controller (ECU) that the probe car 10 has. The in-vehicle device 100 may also be a data communication module (DCM) with communication capabilities.

The in-vehicle device 100 can be configured as a computer with a processor such as a CPU or GPU, main memory such as RAM or ROM, and auxiliary storage such as EPROM, hard disk drive, or removable media. An operating system (OS), various programs, various tables, etc. are stored in the auxiliary memory device, and by executing the programs stored there, each function that meets a given purpose can be realized, as described below. However, some or all of the functions may be realized by hardware circuits such as ASICs or FPGAs.

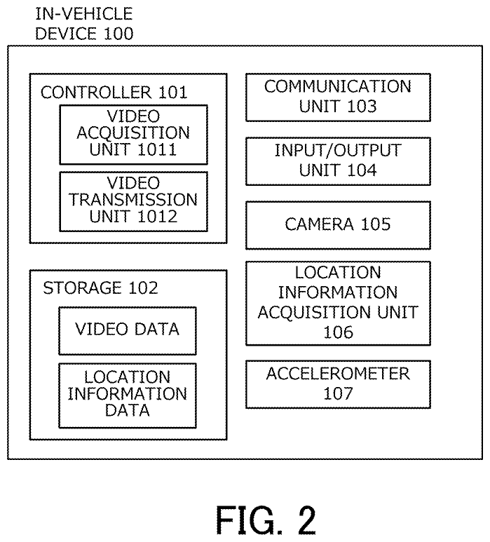

FIG. 2 shows the system configuration of the in-vehicle device 100.

The in-vehicle device 100 comprises a controller 101, a storage 102, a communication unit 103, an input/output unit 104, a camera 105, a location information acquisition unit 106, and an accelerometer 107.

The controller 101 is an arithmetic unit that implements various functions of the in-vehicle device 100 by executing a predetermined program. The controller 101 may be realized by, for example, a CPU.

The controller 101 is composed of a video acquisition unit 1011 and a video transmission unit 1012 as functional modules. These functional modules may be realized by executing the stored program by the CPU.

The video acquisition unit 1011 captures video through the camera 105, described below, and stores it in the storage 102. The video acquisition unit 1011 creates a new storage area (e.g., folder, directory, etc.) when the device is turned on.

The video acquisition unit 1011 captures video via the camera 105 while the in-vehicle device 100 is in operation, and stores the obtained data (video data) in the storage 102. Video data is stored in file units. There is an upper limit to the length of video corresponding to a single file (e.g., 1 minute, 5 minutes), and if the upper limit is exceeded, a new file is generated. If the storage capacity is insufficient, the video acquisition unit 1011 deletes the oldest file to free up space and continues imaging.

Furthermore, the video acquisition unit 1011 acquires the location information of the vehicle via the location information acquisition unit 106 described below at predetermined intervals (e.g., every second) and stores it as location information data.

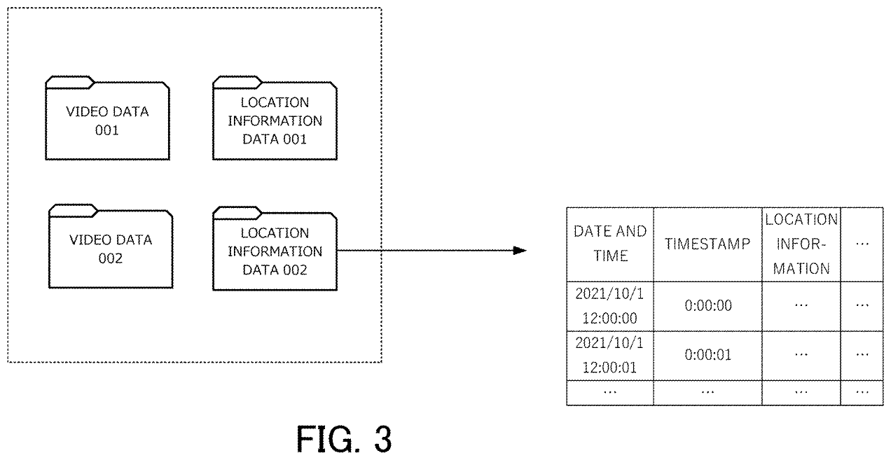

FIG. 3 shows an overview of the video data and location information data stored in the storage 102. As illustrated in the figure, video data and location information data correspond one-to-one. By associating and storing both video data and location information data, it is possible to determine the vehicle's driving position after the fact.

The video transmission unit 1012 transmits the stored video data to the server apparatus 200 at a predetermined timing. A predetermined timing may be a timing that arrives periodically. For example, the video transmission unit 1012 may transmit the video data recorded in the previous file to the server apparatus 200 at the timing when the file is newly generated.

The storage 102 is a memory device that includes a main memory and an auxiliary memory. An operating system (OS), various programs, various tables, etc. are stored in the auxiliary memory, and each function that meets a given purpose, as described below, can be realized by loading the programs stored there into the main memory and executing them.

The main memory may include RAM (Random Access Memory) and ROM (Read Only Memory). Auxiliary storage devices may also include EPROM (Erasable Programmable ROM) and hard disk drives (HDD, Hard Disk Drive). In addition, auxiliary storage devices may include removable media, i.e., portable recording media.

The storage 102 stores the data generated by the controller 101, i.e., video data and location information data.

The communication unit 103 is a wireless communication interface for connecting the in-vehicle device 100 to a network.

The communication unit 103 is configured to communicate with the server apparatus 200, for example, through communication standards such as mobile communication networks, wireless LAN, and Bluetooth (registered trademark).

The input/output unit 104 is a unit that accepts input operations performed by the user and presents information to the user. The input/output unit 104 consists of, for example, an LCD or touch panel display and hardware switches.

The camera 105 is an optical unit that includes an image sensor for acquiring images. The camera 105 is mounted facing the front of the vehicle.

The location information acquisition unit 106 calculates location information based on positioning signals transmitted from positioning satellites (also referred to as GNSS satellites). The location information acquisition unit 106 may include an antenna that receives radio waves transmitted from a GNSS satellite.

The accelerometer 107 is a sensor that measures the acceleration applied to the device. The measurement results are supplied to the controller 101, which can then determine that an impact has been applied to the vehicle.

Next, the server apparatus 200 is described.

The server apparatus 200 is a device that controls the operation of the autonomous vehicle 300. The server apparatus 200 also has a function to generate a map showing the traffic volume of large-sized vehicles based on the video data acquired from multiple probe car 10 (in-vehicle device 100).

In the following description, large-sized vehicles are assumed to be vehicles (e.g., large trucks, large buses, etc.) that can achieve slipstream effects by leading the formation.

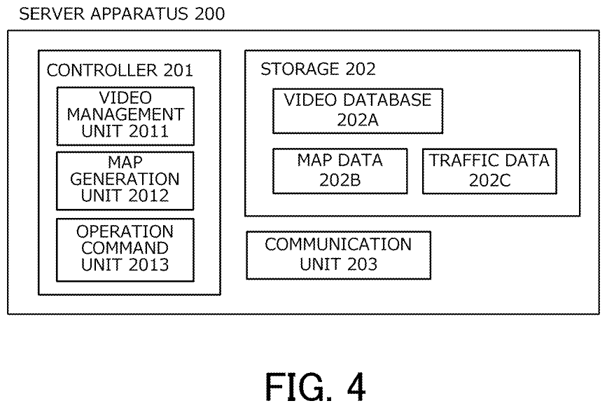

FIG. 4 shows a detailed view of the components of the server apparatus 200 included in the vehicle system.

The server apparatus 200 can be configured as a computer with a processor such as a CPU or GPU, main memory such as RAM or ROM, and auxiliary storage such as EPROM, hard disk drive, or removable media. The operating system (OS), various programs, various tables, etc., are stored in the auxiliary memory device, and the programs stored there are loaded into the work area of the main memory device and executed. The program is loaded into the work area of the main memory, executed, and each component, etc. is controlled through the execution of the program. However, some or all of the functions may be realized by hardware circuits such as ASICs or FPGAs.

The server apparatus 200 is composed of a controller 201, a storage 202, and a communication unit 203.

The controller 201 is an arithmetic unit that governs the control performed by the server apparatus 200. The controller 201 can be realized by an arithmetic processor such as a CPU.

The controller 201 consists of a video management unit 2011, a map generation unit 2012, and an operation command unit 2013 as functional modules. Each functional module may be realized by executing a stored program by the CPU.

The video management unit 2011 executes the process of collecting video data transmitted from multiple probe cars 10 (in-vehicle device devices 100). The video management unit 2011 divides the received video data into predetermined road segments (e.g., based on the map data 202B described below) and executes the process of storing the data in the storage 202 (video database 202A) described below.

The map generation unit 2012 performs the following processes based on multiple video data collected from multiple probe cars 10.

### (1) Detecting Large-Sized Vehicles from Each In-Vehicle Video and Counting the Number of Vehicles

For example, for each of the multiple frames that make up the in-vehicle video, a large-sized vehicle detection process is performed and the number of large-sized vehicles detected is counted for each road segment.

The presence of large-sized vehicles can be recognized, for example, by segmentation techniques. Segmentation technology is a technique for classifying objects in an image into multiple classes, which can be achieved mainly through machine learning models. Segmentation can be used to assign labels to multiple objects in the image, such as “sky,” “nature,” “other vehicles,” “buildings,” “lane boundaries,” “roads,” and “own vehicle,” for example.

The class “large-sized vehicles” is defined in this embodiment. In other words, the area corresponding to a large-sized vehicle in the image (hereafter referred to as “detection area”) can be identified.

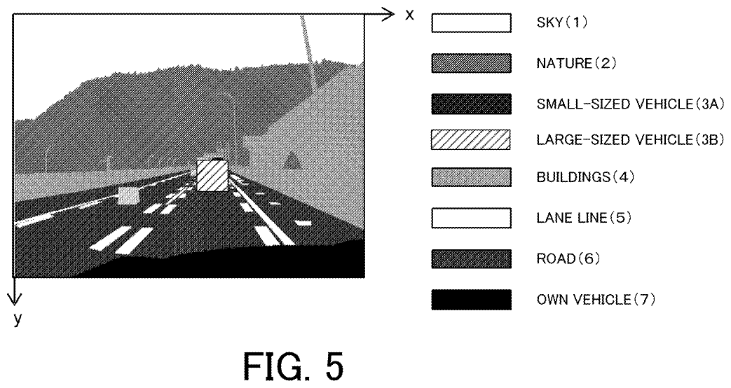

FIG. 5 is an example of an image (also called a label image) that has been labeled by the segmentation process (classification process).

The map generation unit 2012, for example, performs a segmentation process for each frame of in-vehicle video corresponding to a certain road segment. Then, by tracking the detection area over time from its appearance to its disappearance, it is possible to determine how many large-sized vehicles were traveling on the corresponding road segment.

For example, if N detection areas are detected between the start and end frames, it can be determined that there were (at least) N large-sized vehicles in the vicinity of the probe car 10.

Such a process can determine how many large-sized vehicles were in the vicinity of each of the probe cars 10 at a given time.

The results of the determination are reflected in the traffic data 202C described below.

### (2) Process to Assign the Traffic Volume of Large-Sized Vehicles to Each Road Segment Based on the Counting Results

According to the aforementioned process, the number of large-sized vehicles located in the vicinity of one of the probe cars 10 can be counted.

On the other hand, by integrating the results of counts performed on multiple in-vehicle videos (captured by multiple probe car), it is possible to obtain the volume of large-sized vehicle traffic that was traveling on a given road segment at nearby times.

The traffic volume calculated here does not necessarily have to represent the exact number of vehicles (e.g., number of vehicles passing per hour, etc.). For example, a value representing the number of large-sized vehicles (evaluation value) may be calculated based on the number of large-sized vehicles captured by the multiple probe car 10. In this embodiment, a rating value that ranges from 0 to 100 is calculated as the traffic volume of large-sized vehicle traffic.

The same large-sized vehicle may be captured by multiple probe car 10. Therefore, a process may be used to determine that the same large-sized vehicle has been detected in duplicate. For example, if license plate recognition is performed for a large-sized vehicle and the same license plate is detected at several nearby timings, it may be determined to be a duplicate and one of the large-sized vehicle may be deleted. If the time and location of the large-sized vehicles detected are in close proximity, it may be determined that they are duplicates and one of them may be deleted.

The map generation unit 2012 also generates a map showing the number of large-sized vehicles (hereafter referred to as a traffic volume map) based on the rating assigned to each road segment.

The operation command unit 2013 generates an operation plan for a given autonomous vehicle 300 and transmits the generated operation plan to the autonomous vehicle 300.

An operation plan is data that instructs the autonomous vehicle 300 on the tasks to be performed. If the autonomous vehicle 300 is a vehicle that transports passengers, tasks include boarding and disembarking passengers, driving to a predetermined point, and so on. If the autonomous vehicle 300 is a vehicle that transports luggage, the tasks include picking up the luggage, driving to a predetermined point, handing over the luggage, etc. If the autonomous vehicle 300 is a mobile store, tasks include driving to a predetermined point, opening a store at the arrival point, etc.

The operation command unit 2013 generates an operation plan that combines multiple tasks, and the autonomous vehicle 300 can provide a given service by completing tasks in sequence according to the operation plan. In this embodiment, the operation plan includes the route to be traveled by the autonomous vehicle 300.

Furthermore, the operation command unit 2013 generates a travel route for the autonomous vehicle 300 based on the traffic volume map.

The travel route of an autonomous vehicle 300 is usually determined based on distance and time required. However, in some situations, a route may be traveled with more large-sized vehicles, even if it means taking a slightly longer detour. Such a case, for example, is when the running battery is low. When large-sized vehicles can run in formation as the lead vehicle, the amount of energy (electricity) required for traveling may decrease as a result, even if the traveling distance is slightly longer, because the reduction in air resistance is expected to improve the electricity cost.

Under these predetermined conditions, the operation command unit 2013 uses the traffic volume map to generate travel routes based on the “heavy traffic volume of large-sized vehicles”.

The above is just an example and may be modified depending on the design as to under what conditions the traffic volume map is to be used.

The storage 202 comprises a main memory and an auxiliary memory. The main memory is the memory in which the programs executed by the controller 201 and the data used by the control programs are developed. The auxiliary storage device is a device in which programs executed in the controller 201 and data used by the control program are stored.

In addition, video database 202A, map data 202B, and traffic data 202C are stored in storage 202.

The video database 202A is a database that stores multiple in-vehicle videos transmitted from the in-vehicle device 100.

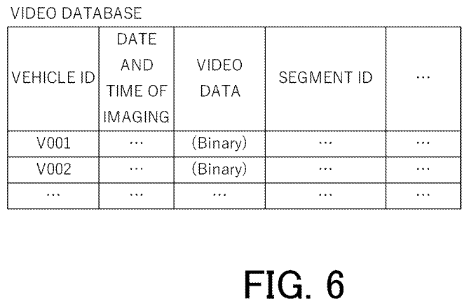

FIG. 6 is an example of data stored in the video database 202A. As shown in the figure, the video database 202A includes the identifier of the vehicle that transmitted the in-vehicle video, the date and time of imaging, the video data, and the road segment identifier.

The stored data may be deleted at a predetermined timing (e.g., after a predetermined amount of time has elapsed since receipt).

Map data 202B is a database that stores road maps. A road map can be represented by a set of nodes and links, for example. Map data 202B includes definitions of nodes, links, and road segments contained in the links. A road segment is a unit section of a road link divided into predetermined lengths. Each road segment may by associated with location information (latitude, longitude), address, point name, road name, etc.

Traffic data 202C contains information about large-sized vehicles detected in the video data. The map generation unit 2012 records the number of large-sized vehicles detected on a given road segment in the traffic data 202C, as described above. Other information about the detected large-sized vehicles may be recorded in the traffic data 202C. Such information includes, for example, license plate information and features extracted from the image.

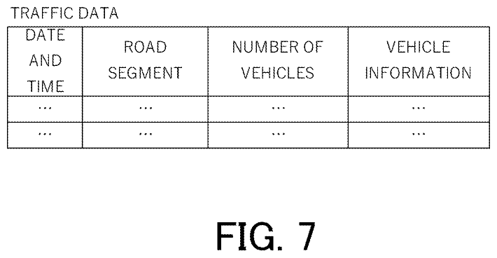

FIG. 7 is an example of traffic data 202C.

In this example, traffic data 202C includes fields for date and time, road segment, number of vehicles, and vehicle information.

The date/time field contains information about the date and time the in-vehicle video was captured. The road segment field contains data to identify the road segment of interest.

The number of vehicles field contains a value representing the number of detected large-sized vehicles. The vehicle information field contains other information about the detected large-sized vehicles (e.g., license plate information, information about vehicle characteristics, etc.).

In this example, the number of large-sized vehicles was recorded for each road segment. However, if the location of a large-sized vehicle can be accurately identified, the traffic data may be data that associates the location information of the large-sized vehicle with the date and time the onboard video was captured.

The communication unit 203 is a communication interface for connecting the server apparatus 200 to a network.

The communication unit 203 comprises, for example, a network interface board and a wireless communication interface for wireless communication.

The configurations shown in FIGS. 2 and 4 are examples, and all or some of the illustrated functions may be performed using specially designed circuits. Programs may also be stored or executed by a combination of main and auxiliary memory devices other than those shown in the figure.

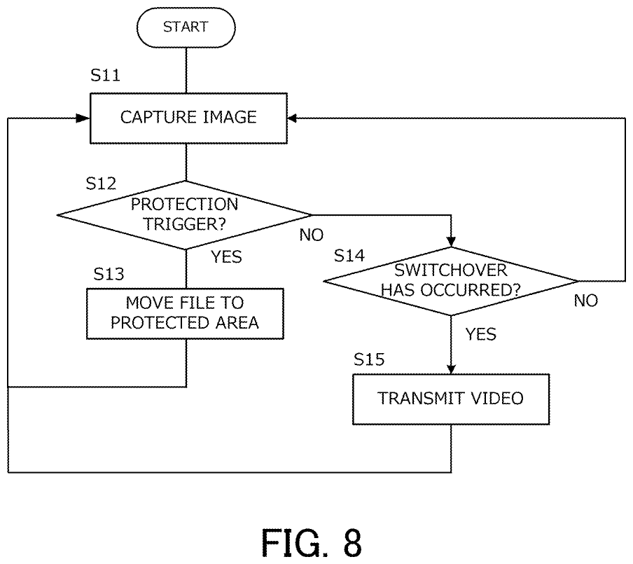

The following section describes the details of the processes performed by each device in the vehicle system. FIG. 8 is a flowchart of the process performed by the in-vehicle device 100. The illustrated process is repeatedly executed by the controller 101 while power is supplied to the in-vehicle device 100.

In step S11, the video acquisition unit 1011 captures in-vehicle video using the camera 105. In this step, the video acquisition unit 1011 records the video signals output from the camera 105 as video data in a file. As explained in FIG. 3, the file is divided into sections of predetermined length. If the storage space in the storage 102 is insufficient, the oldest file is overwritten first. In this step, the video acquisition unit 1011 periodically acquires location information via the location information acquisition unit 106 and records the acquired location information in the location information data.

In step S12, the video acquisition unit 1011 determines whether a protection trigger has occurred. For example, a protection trigger occurs when a shock is detected by the accelerometer 107 or when the user presses a save button on the device body. In this case, the process moves to step S13, where the video acquisition unit 1011 moves the file that is currently being recorded to the protected area. A protected area is an area where automatic overwriting of a file does not take place. This protects files that record important scenes.

If no protection trigger has occurred, the process transitions to step S14 to determine if a file switch has occurred. As mentioned above, there is an upper limit to the length of video corresponding to a single file (e.g., 1 minute, 5 minutes), and when the upper limit is exceeded, a new file is generated. If a switchover occurs, the process transitions to step S15. Otherwise, the process returns to step S11.

In step S15, the video transmission unit 1012 transmits the target video data together with location information data to the server apparatus 200.

Upon receiving the video data, the server apparatus 200 (video management unit 2011) identifies the road segment traveled by the probe car 10 based on the location information data, divides the video data by road segment, and stores it in the video database 202A. In the following description, one video data corresponds to one road segment.

Next, the details of the process performed by the server apparatus 200 will be explained.

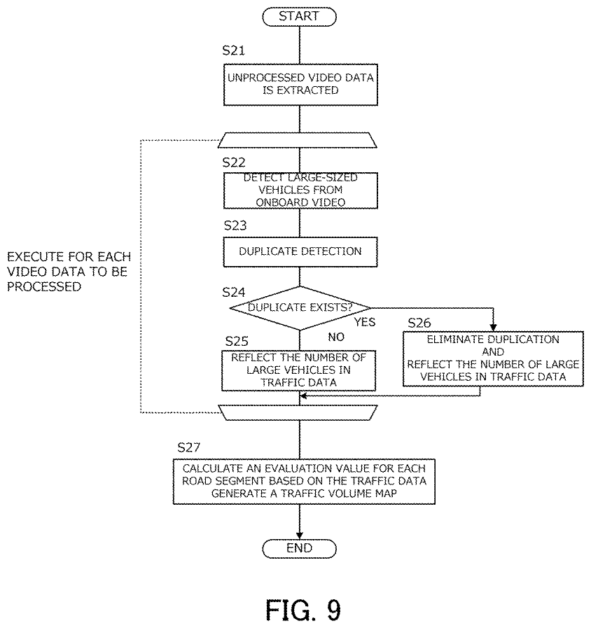

FIG. 9 is a flowchart of the process of generating a traffic volume map based on the collected video data. This process is performed by the map generation unit 2012 at a predetermined timing after the video data has been accumulated.

First, in step S21, unprocessed video data is extracted from the video database 202A. In this step, video data received within the most recent predetermined period (e.g., from 10 minutes ago to the present) may be extracted.

Steps S22-S26 are performed for each of the extracted video data.

First, in step S22, segmentation processing is performed on each frame of the target video data to detect large-sized vehicles.

This step determines how many large-sized vehicles were in the vicinity of the 10 probe car. Therefore, the map generation unit 2012 may determine the number of large-sized vehicles present in the vicinity of the probe car 10 based on the detection process performed for each frame over time.

Steps S23 and S24 determine whether the large-sized vehicles detected in step S22 have already been detected in other on-board videos.

For example, if the traffic data 202C contains license plate information for large-sized vehicles, this step determines whether there are combinations that satisfy the following conditions.
(1) Match each other's license plate information
(2) Date and time are in close proximity

If these conditions are met, it means that the newly detected large-sized vehicles have already been detected from other onboard videos. If this is the case (step S24—Yes), the process transitions to step S26, where the duplicates are removed and the remaining information is stored in traffic data 202C.

If the above conditions are not met, the process transitions to step S25, where information on large-sized vehicles is stored in traffic data 202C.

In this case, license plate information and information on vehicle characteristics may be obtained.

In the example above, duplicates were determined based on license plate information, but duplicates may also be determined based on other information. For example, duplicates can be determined by the paint on the body of a large-sized vehicle, the letters on the body (e.g. company name), etc.

Furthermore, if the vehicle body has no features, the overlap determination may be based on location information and time information. For example, if the location corresponding to each frame of the video can be identified, the driving position of a large-sized vehicle may be estimated. In this case, two vehicles that are in close proximity in both driving position and date/time can be considered to be the same vehicle.

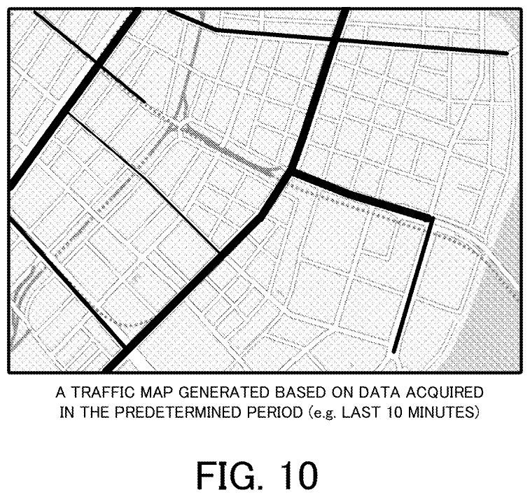

In step S27, the map generation unit 2012 calculates an evaluation value (i.e., a value representing the traffic volume of large-sized vehicles) for each road segment based on the traffic data 202C and generates a traffic volume map. FIG. 10 shows an example of a traffic volume map generated by the map generation unit 2012. In the illustrated example, the thickness of the line represents the volume of large-sized vehicle traffic.

The generated traffic volume map is associated with the date and time the in-vehicle video was captured and stored in storage 202.

Next, the process by which the server apparatus 200 commands the autonomous vehicle 300 to operate based on the generated traffic volume map is described.

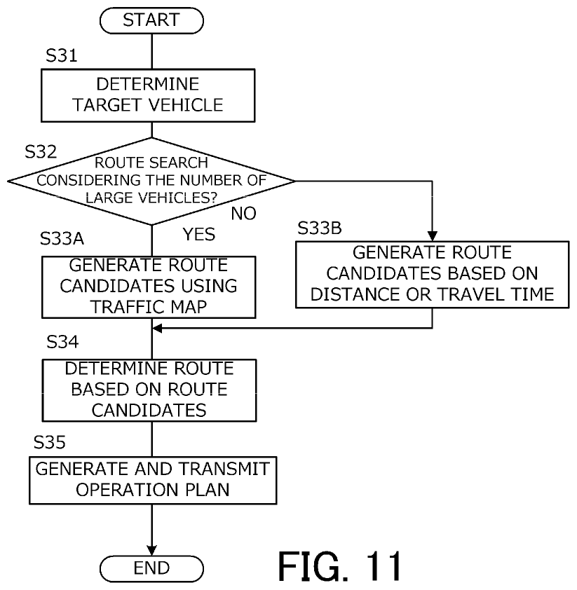

FIG. 11 is a flowchart of the process by which the server apparatus 200 commands the autonomous vehicle 300 to operate. The process illustrated in the figure is executed by the operation command unit 2013 when the trigger to dispatch the autonomous vehicle 300 occurs. For example, when an autonomous vehicle is used to provide transportation services, the process shown in the figure is triggered when a dispatch request is received from a passenger.

In step S31, the system determines the vehicle to be dispatched from among the multiple autonomous vehicles 300 under the system's control based on the dispatch request and other factors. The vehicles to be dispatched can be determined based on, for example, the requested service, the current location of each vehicle, and the task each vehicle is performing. For example, if the requested service is a passenger transportation service, an autonomous vehicle 300 that has passenger transportation capabilities and can arrive at the specified point within a given time is selected. To this end, the server apparatus 200 may maintain data on the status of the autonomous vehicle 300.

In step S32, it is decided whether or not the route search for the target vehicle, autonomous vehicle 300, is based on the number of large-sized vehicles (in other words, whether or not the route search is performed with fuel/electricity cost priority). For example, if any of the following conditions are met, a positive decision is made in this step.
(1) When the subject vehicle is an electric vehicle
(2) When the subject vehicle is an electric vehicle and the remaining capacity of the drive battery is below a predetermined value.
(3) When the subject vehicle is capable of automatic formation driving or automatic follow-up driving
(4) When the designation is made by the operation manager of the subject vehicle

If the decision is positive in step S32, the process transitions to step S33A.

In step S33A, one or more candidate routes are generated using the traffic volume map. The criterion for generating candidate routes is the volume of large-sized vehicle traffic. In other words, route candidates are generated with priority given to roads where more large-sized vehicles are present.

If a negative decision is made in step S32, the process transitions to step S33B.

In step S33B, one or more candidate routes are generated without using the traffic volume map. In other words, as in the past, candidate routes are generated based on distance or time required.

In step S34, the route to be adopted is determined from among the route candidates. In this step, routes are selected that conform to predetermined criteria, such as “Priority on non-highway” or “Priority on highway” for example.

In step S35, the operation plan corresponding to the selected autonomous vehicle 300 is generated. An operation plan is a set of tasks to be performed by the autonomous vehicle 300.

Tasks include, for example, tasks to travel to a specified point, to embark and disembark passengers, to load and unload luggage, etc. Tasks also include the paths along which the autonomous vehicle 300 will travel. The generated operation plan is transmitted to the target autonomous vehicle 300.

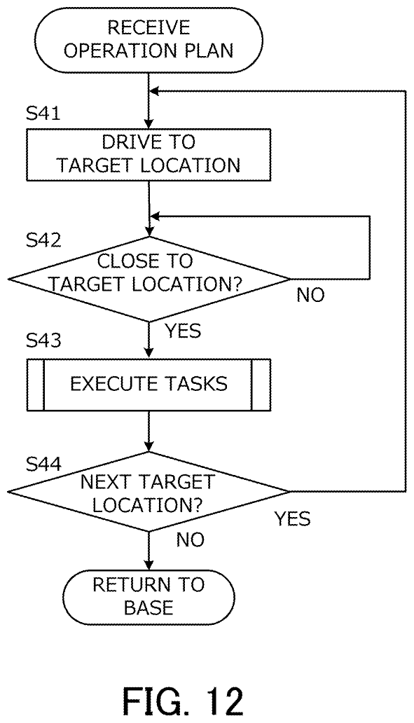

FIG. 12 is a flowchart of the process performed by the autonomous vehicle 300 upon receipt of the operation plan. The process is initiated when the autonomous vehicle 300 receives the operation plan from the server apparatus 200.

First, in step S41, driving to the target point (i.e., the point designated by the server apparatus 200) according to the specified route, is started.

When the autonomous vehicle 300 approaches the target location (step S42), it searches for a nearby location where it can stop, parks, and executes the task (step S43).

When the task is completed, the autonomous vehicle 300 determines whether there is a next target location according to the operation plan (step S44), and if there is a next target location, the operation continues. If there is no next target point (i.e., all tasks included in the operation plan have been completed), the vehicle returns to its base.

As explained above, the server apparatus 200 of the first embodiment generates a map representing the traffic volume of large-sized vehicles based on the in-vehicle video transmitted from the probe car 10, and determines the operation route of the automated vehicle based on the map. This makes it possible to have the automatic vehicle actively drive in formation or following, thereby reducing the energy consumption required for driving.

### Variant 1 of the First Embodiment

In the first embodiment, the server apparatus 200 generated an operation plan for the autonomous vehicle 300, but the server apparatus 200 may not generate an operation plan, but only generate a traffic volume map. For example, the server apparatus 200 may be configured to distribute the generated traffic volume map to the autonomous vehicle 300. In this case, the autonomous vehicle 300 may autonomously generate an appropriate operation plan based on the received traffic volume map.

The server apparatus 200 may also generate data other than in map format as data representing large-sized vehicle traffic volume. For example, traffic data such as that illustrated in FIG. 9 or other data generated based on traffic data may be distributed to multiple autonomous vehicles 300.

The server apparatus 200 may be a device that provides only route finding services. The server apparatus 200 may, for example, perform a route search in response to a request from the autonomous vehicle 300 or other autonomous vehicles, taking into account the large number of large-sized vehicles, and return the results. In this case, traffic volume maps do not necessarily need to be generated.

### Second Embodiment

In the first embodiment, the traffic volume map was generated using video data received in the most recent period (e.g., the past 10 minutes). In other words, the traffic volume map generated in the first embodiment reflects the latest road conditions.

On the other hand, large-sized vehicle traffic volume can take a similar pattern depending on the day of the week and time of day.

Therefore, the server apparatus 200 may generate and store multiple patterns of traffic volume maps based on the accumulated video data, and use such traffic volume maps to control the operation of the autonomous vehicle 300.

The second embodiment of implementation is to generate and use multiple patterns of traffic volume maps for each day of the week and time of day.

In the second embodiment, all video data received in the past predetermined period (e.g., the past month) are subject to processing in step S21.

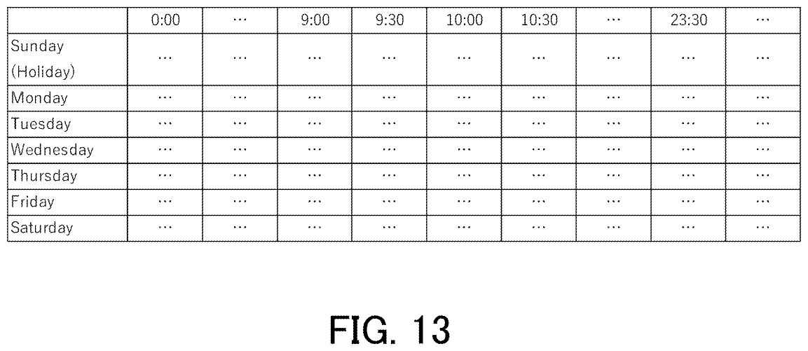

In the second embodiment, traffic data is generated for each pattern, and a traffic volume map is generated for each pattern in step S27. Patterns may be by day of the week or by categories such as weekdays, holidays, and national holidays. It may also be by time of day. FIG. 13 illustrates the multiple patterns in tabular form. In this example, the pattern is defined by dividing the time period every 30 minutes.

In the second embodiment, in step S27, if a traffic volume map for the target pattern already exists, it is overwritten and updated. This will, for example, update the traffic volume map based on data that has occurred over the past month.

The updated traffic volume may be determined by weighted averaging or other techniques. The weight for taking a weighted average may be determined based on the date the in-vehicle video was captured or other factors. For example, the smaller the number of days elapsed since the imaging date, the greater the weight may be given. Conversely, the older the imaging date, the smaller the weight may be.

According to the second embodiment, traffic volume maps are generated and used for each pattern defined by the day of the week and time of day, so that the traffic volume of large-sized vehicles can be determined more accurately according to the day of the week and time of day. It will also be possible to specify a future date and time for route search.

### Third Embodiment

In the first and second embodiments, the server apparatus 200 detects large-sized vehicles based on the video transmitted from the probe car 10. In contrast, the third embodiment is an embodiment in which the in-vehicle device 100 mounted on the probe car 10 executes the detection process for large-sized vehicles and transmits the results to the server apparatus 200.

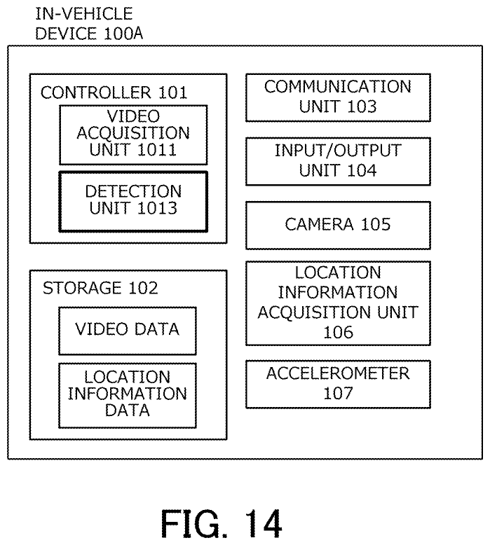

FIG. 14 is a system configuration diagram of the third embodiment of the 100A in-vehicle device. In the third embodiment, the in-vehicle device 100A (controller 101) is configured with a detection unit 1013 instead of a video transmission unit 1012.

The detection unit 1013 processes the video data acquired by the video acquisition unit 1011 to detect large-sized vehicles and transmits the results to the server apparatus 200.

Specifically, for each frame contained in the latest video data, the aforementioned process for detecting large-sized vehicles (e.g., segmentation process) is performed. The process may be performed frame by frame or at predetermined intervals (e.g., 1 second).

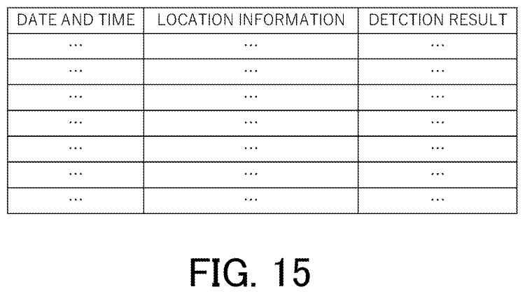

The results of the process are sent to the server apparatus 200. FIG. 15 is an example of data generated by the detection unit 1013 and sent to the server apparatus 200 (hereinafter referred to as “detection result data”).

The date and time field contains the date and time the in-vehicle video was captured. The location information field contains the location information (e.g., latitude and longitude) of the point where the detection was made. The Detection Result field contains the data obtained as a result of detecting large-sized vehicles. The field may contain the number of detected large-sized vehicles as a numerical value, or it may contain a label image, as illustrated in FIG. 5, obtained as a result of the segmentation process. In addition, additional information about large-sized vehicles (e.g., license plate information, features, etc.) may be stored.

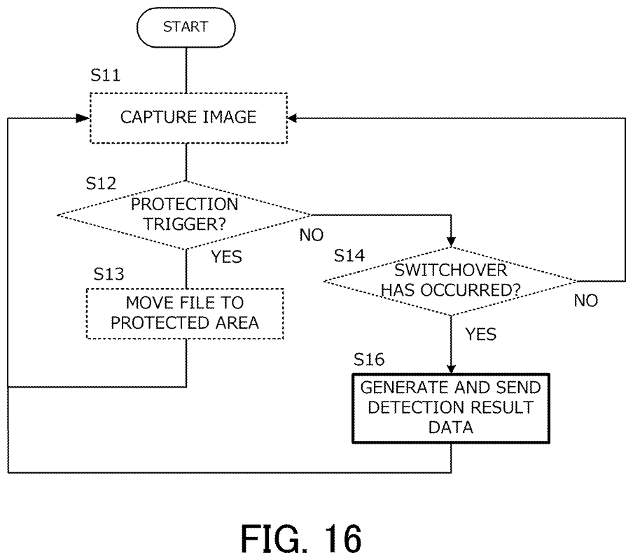

FIG. 16 is a flowchart of the process performed by the in-vehicle device 100A in the third embodiment. Steps S11-S14 are the same as in the first embodiment. In this embodiment, in step S16, the detection unit 1013 executes the process of detecting large-sized vehicles and generating detection result data. The generated detection result data is sent to the server apparatus 200.

Next, the server apparatus 200 in the third embodiment is described.

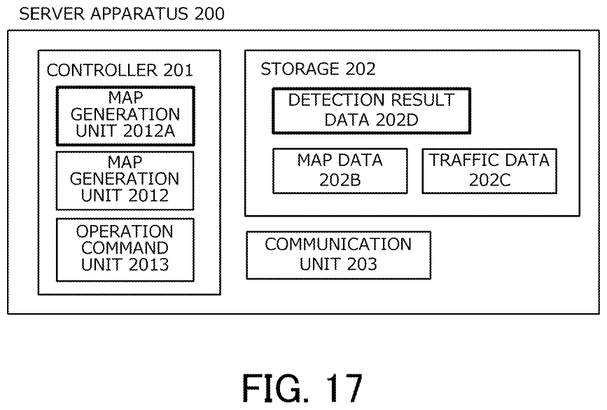

FIG. 17 is a system configuration diagram of the server apparatus 200 in the third embodiment. In the third embodiment, the server apparatus 200 does not have a video management unit 2011 and is configured to store detection result data transmitted from the in-vehicle device 100A.

The map generation unit 2012A stores the detection result data received from the in-vehicle device 100A in the storage 202 (202D) from time to time.

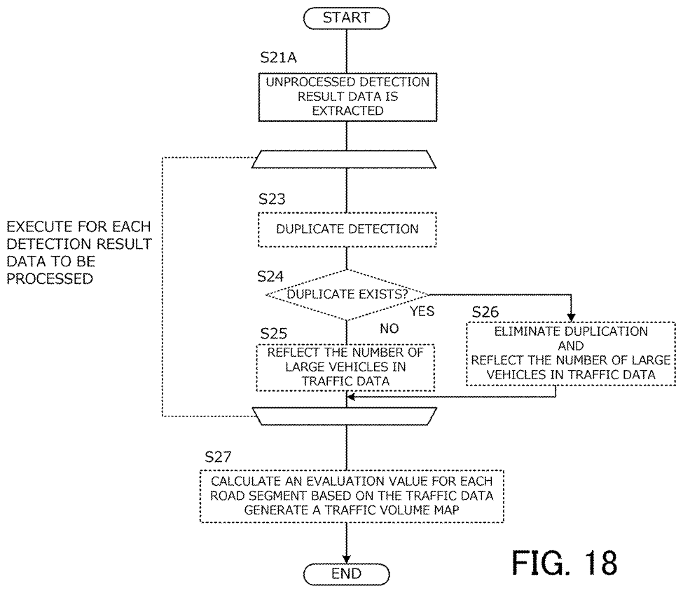

FIG. 18 is a flowchart of the process performed by server apparatus 200 (map generation unit 2012A) in the third embodiment.

In step S21A, unprocessed detection result data is extracted from the storage 202. In the third embodiment, step S22 is omitted.

In steps S23-S26, the same method as in the first embodiment is used to determine the overlap of large-sized vehicles, and the results are reflected in the traffic data.

In step S27, as in the first embodiment, the map generation unit 2012 generates a traffic map based on the traffic data 202C.

As explained above, the detection process for large-sized vehicles can also be performed on the in-vehicle device side. According to this embodiment, video data does not need to be transmitted each time, thus reducing the load on the network.

### Fourth Embodiment

In the first through third embodiments, all detected heavy large-sized vehicles were subject to counting. On the other hand, there are some large-sized vehicles that are not appropriate to be followed, such as vehicles parked on the shoulder or traveling at low speeds. The fourth embodiment is to detect the presence of such large-sized vehicles and exclude them from the count.

In the fourth embodiment, the speed information of the probe car 10 is added to the video data. Speed information may be included in the location information data shown in FIG. 3. In the fourth embodiment, after step S25 (S26) is executed, the map generation unit 2012 executes the process of estimating the speed of the detected large-sized vehicles. The speed of the large-sized vehicle can be estimated, for example, based on the speed of the probe car 10 at the time of shooting and the time the large-sized vehicle remains in the camera's field of view.

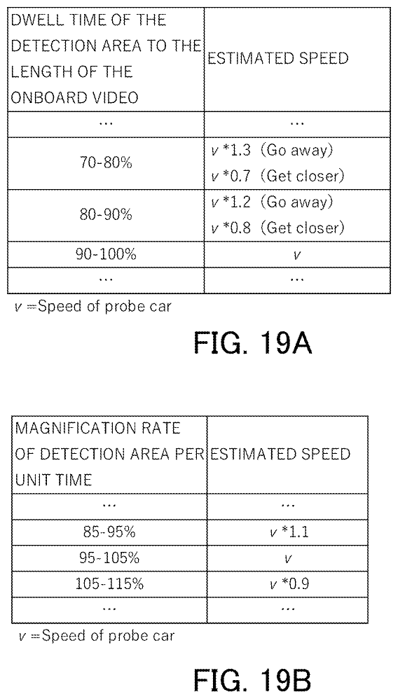

This is because the higher the relative speed between the probe car 10 and the large-sized vehicle, the faster the area corresponding to the large-sized vehicle (detection area) disappears from the camera's field of view. Conversely, if the detection area continuously stays within the field of view, the large-sized vehicle in question can be presumed to be traveling at a speed equivalent to that of the probe car. Such estimation can be based, for example, on data defining the relationship between the residence time of the detection area and the estimated speed (e.g., FIG. 19A).

The speed of large-sized vehicles can also be estimated based on the size of the detection area over time. For example, if a large-sized vehicle is moving away from the probe car at a higher relative speed, the size of the detection area will shrink faster; if a large-sized vehicle is approaching the probe car at a higher relative speed, the size of the detection area will expand faster. Therefore, the speed of a large-sized vehicle can be estimated by determining the rate of expansion (contraction) of the detection area per unit time. Such estimation can be based, for example, on data (e.g., FIG. 19B) that defines the relationship between the rate of expansion of the detection area per unit time and the estimated speed.

If the speed estimated here is below a predetermined value (e.g., the lower limit of speed at which it is reasonable to perform a follow-up run), the detected large-sized vehicle is excluded from the count. The rest of the process is the same as in the other embodiments.

According to the fourth embodiment, it is possible to target for detection only large-sized vehicles that are traveling at a speed at which it is reasonable to perform a follow-up run.

### Other Variants

The above embodiments are examples only, and the present disclosure may be modified and implemented as appropriate without departing from the gist thereof.

For example, the processes and structure described in this disclosure may be freely combined as long as no technical contradictions arise.

In the description of the embodiment, the probe car 10 and the autonomous vehicle 300 are illustrated as separate vehicles, but the autonomous vehicle 300 may function as a probe car.

The process described as being performed by one device may be shared and executed by multiple devices. Alternatively, the processes described as being performed by different devices may be performed by one device. In a computer system, it is possible to flexibly change what hardware configuration (server configuration) is used to realize each function.

This disclosure can also be realized by supplying a computer program implementing the functions described in the above embodiments to a computer, and having one or more processors of the computer read and execute the program. Such computer programs may be provided to a computer by a non-transitory computer-readable storage medium that can be connected to the computer's system bus, or may be provided to a computer over a network. Non-transitory computer-readable storage media include, for example, magnetic disks (floppy (registered trademark) disks, hard disk drives (HDD), etc.), optical disks (CD-ROM, DVD disks and Blu-ray disks, etc.) of any type, read-only memory (ROM), random access memory (RAM), EPROM, EEPROM, magnetic cards, flash memory, optical cards, and any type of media suitable for storing electronic instructions.

What is claimed is:

1. An information processing apparatus comprising a controller configured to execute:
determining traffic volume of large-sized vehicles in a vicinity of a first vehicle based on first data transmitted from the first vehicle; and
mapping information on the traffic volume of the large-sized vehicles to road segments based on the results of the determination.

2. The information processing apparatus according to claim 1, wherein
the first data includes an image captured by an onboard camera, and the controller detects the large-sized vehicle from the image.

3. The information processing apparatus according to claim 2, wherein
the first data includes a results of detection process of the large-sized vehicles on the images captured by an onboard camera.

4. The information processing apparatus according to claim 1, wherein
the controller generates a route for a second vehicle based on results of the mapping.

5. The information processing apparatus according to claim 4, wherein
the controller commands the second vehicle to travel along the route.

6. The information processing apparatus according to claim 1, wherein
the controller transmits results of the mapping to a second vehicle.

7. The information processing apparatus according to claim 4, wherein
the second vehicle is a vehicle capable of automatically following the large-sized vehicle.

8. The information processing apparatus according to claim 1, wherein
the first data includes time information and location information, and
the controller determines position and time at which the large-sized vehicle was present based on the first data transmitted from a plurality of the first vehicles, and determines the traffic volume of the large-sized vehicles based on results of the determination.

9. The information processing apparatus according to claim 8, wherein
the controller executes the determination of the traffic volume by excluding the large-sized vehicles detected in duplicate by the plurality of the first vehicles, based on the time information and location information.

10. The information processing apparatus according to claim 1, wherein
the controller determines speed of the large-sized vehicle in the vicinity of the first vehicle based on the first data.

11. The information processing apparatus according to claim 10, wherein
the controller determines the traffic volume by excluding large-sized vehicles whose speed is below a predetermined value.

12. An information processing system comprising an on-board device, mounted on a first vehicle, and a server device capable of communicating with the on-board device, wherein
the on-board device comprises a first controller configured to execute: detecting a large-sized vehicle in a vicinity of the first vehicle based on an image captured by an on-board camera, and transmitting first data including a result of the detection to the server device;
the server device comprises a second controller configured to execute: determining, based on the first data, traffic volume of the large-sized vehicles in a vicinity of the first vehicle; and mapping information on the traffic volume of the large-sized vehicles to road segments based on the results of the determination.

13. The information processing system according to claim 12, wherein
the first controller executes object classification on images captured by the on-board camera.

14. The information processing system according to claim 13, wherein
the first data data is a label image obtained as a result of the classification.

15. The information processing system according to claim 12, wherein
the second controller generates a route for a second vehicle based on results of the mapping.

16. The information processing system according to claim 15, wherein
the second controller commands the second vehicle to travel along the route.

17. The information processing system according to claim 12, wherein
the second controller transmits results of the mapping to a second vehicle.

18. The information processing system according to claim 15, wherein
the second vehicle is a vehicle capable of automatically following the large-sized vehicle.

19. The information processing system according to claim 12, wherein
the first data includes time information and location information, and
the second controller determines position and time at which the large-sized vehicle was present based on the first data transmitted from a plurality of the first vehicles, and determines the traffic volume of the large-sized vehicles based on results of the determination.

20. The information processing system according to claim 19, wherein
the second controller executes the determination of the traffic volume by excluding the large-sized vehicles detected in duplicate by the plurality of the first vehicles, based on the time information and location information.
